(19) United States
(12) Patent Application Publication
(10) Pub. No.: US 2017/0226271 A1
(43) Pub. Date: Aug. 10, 2017

(54) Thermally Reversible Crosslinked Polyurethane

(71) Applicant: Lubrizol Advanced Materials, Inc., Cleveland, OH (US)

(72) Inventors: Umit G. Makal, Stow, OH (US); Roger W. Day, Solon, OH (US); David M. Haddleton, Kenilworth (GB); Christopher J. Summers, Gloucester (GB)

(21) Appl. No.: 15/329,017

(22) PCT Filed: Jul. 29, 2015
(86) PCT No.: PCT/US2015/042549

§ 371 Date: Jan. 25, 2017

Related U.S. Application Data
(60) Provisional application No. 62/031,224, filed on Jul. 31, 2014.

(51) Int. Cl. C08G 18/67; C08L 75/04; C08J 3/24; C08G 18/76

(52) U.S. Cl. CPC C08G 18/6765; C08G 18/7621; C08L 75/04; C08J 3/243; C08J 2375/04; C08J 2479/04; C08L 2312/00

(57) ABSTRACT

The polymer compositions described herein include the reaction product obtained from a mixture that includes: (i) a hydroxyl terminated intermediate containing at least one furan functional group; and (ii) a polyisocyanate component. The polymer compositions may further include a polymaleimide compound which may be (a) added as a component of the polymer composition, (b) incorporated into the structure of the hydroxyl terminated intermediate containing at least one furan functional group, or (c) both. The resulting polymer composition is capable of thermally reversible crosslinking. Also described are processes for making such polymer compositions, methods of reversibly increasing and/or decreasing the amount of crosslinking in a polymer composition thermally, through utilization of the Diels-Alder cycloaddition mechanism between furan functional groups and the polymaleimide compound, and methods of using the described furan functional group containing materials to prepare polymer compositions capable of thermally reversible crosslinking.

The polymer compositions described herein include the reaction product obtained from a mixture that includes: (i) a hydroxyl terminated intermediate containing at least one furan functional group; and (ii) a polyisocyanate component. The polymer compositions may further include a polymaleimide compound which may be (a) added as a component of the polymer composition, (b) incorporated into the structure of the hydroxyl terminated intermediate containing at least one furan functional group, or (c) both. The resulting polymer composition is capable of thermally reversible crosslinking Also described are processes for making such polymer compositions, methods of reversibly increasing and/or decreasing the amount of crosslinking in a polymer composition thermally, through utilization of the furan functional groups and the polymaleimide compound, and methods of using the described furan functional group containing materials to prepare polymer compositions capable of thermally reversible crosslinking.

### BACKGROUND

This technology relates to thermally reversible crosslinked polyurethanes which may be classified as “smart materials” and in some instances as self-healing materials.

Smart materials are materials designed to have one or more properties that can be modified in a controlled fashion by external conditions or stimuli, including temperature, moisture, magnetic fields, etc. There are many types of smart materials, including temperature-responsive polymers and self-healing materials. Temperature-responsive polymers undergo significant changes upon changes in temperature, where the change is typically the polymers solubility in a solvent, but can also be other properties. Self-healing materials have an intrinsic ability to repair damage due to normal usage, leading to a longer service life of the material and products made from it.

With more conventional materials, which do not have smart and/or self-healing properties, the initiation of cracks and other types of damage, even on a microscopic level, has been shown to change the physical properties of the material, and so to compromise the performance of the part and/or product made from the material.

Typically, the only means to repair cracks and similar damage is to repair them by hand, which is often unsatisfactory as cracks can be hard to detect. A material that can intrinsically repair damage caused by normal usage could lower production costs of a number of different industrial processes through longer part lifetime, reduction of inefficiency over time caused by degradation, as well as prevent costs incurred by material failure. Further, a polymer that can significantly change one or more of its properties in a controllable and reversible fashion would offer significant advantages over more conventional materials. There would be much more flexibility in the way the materials is used in the construction of other products, the products could be designed to make sure of the reversibility and controllability of the properties in question, leading to performance and end use application not possible for the more conventional materials.

For example, a thermally reversible polymer can be used in shoe molding applications; at lower or service temperature of the material the polymer exhibits sufficient mechanical properties and improved set resistance just like a crosslinked network, yet it becomes thermoplastic and recycle-able at higher temperatures unlike a thermoset polymer.

There is increasing interest in smart materials including self-healing materials. This interest includes a desire for thermally reversible crosslinked polyurethanes.

### SUMMARY

The disclosed technology provides a polymer composition that includes the reaction product obtained from a reaction mixture that includes: (i) a hydroxyl terminated intermediate containing at least one furan functional group; and (ii) a polyisocyanate component.

The disclosed technology provides the described polymer composition where it further includes a polymaleimide compound. The polymaleimide compound may be (a) added as a component of the polymer composition, (b) incorporated into the structure of the hydroxyl terminated intermediate containing at least one furan functional group, or (c) both (a) and (b). The resulting polymer composition is capable of thermally reversible crosslinking

The disclosed technology provides the described polymer composition where the hydroxyl terminated intermediate containing at least one furan functional group includes a polyether polyol containing at least one furan functional group, a polyester polyol containing at least one furan functional group, a polycarbonate polyol containing at least one furan functional group, a polyamide polyol containing at least one furan functional group, or any combination thereof. The reaction mixture may further include (iii) at least one non-furan group containing chain extender. In such embodiments, the furan functional group containing component serves as the polyol component of the polymer while the non-furan group containing component is a conventional chain extender.

The disclosed technology provides the described polymer composition where the hydroxyl terminated intermediate containing at least one furan functional group comprises a short chain glycol chain extender having from about 2 to about 10 carbon atoms, a short chain amine chain extender having from about 2 to about 10 carbon atoms, or any combination thereof. The reaction mixture may further include (iii) at least one non-furan group containing polyol compound. In such embodiments, the furan functional group containing component serves as the chain extender of the polymer while the non-furan group containing component is a conventional polyol component.

The disclosed technology provides the described polymer composition where the hydroxyl terminated intermediate containing at least one furan functional group includes a compound represented by the following structure:

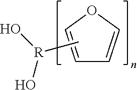

where R is a hydrocarbyl group and n is an integer from 1 to 20.

The disclosed technology provides the described polymer composition where the hydroxyl terminated intermediate containing at least one furan functional group includes at least one compound represented by the following structures:

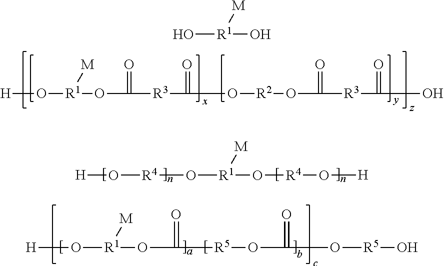

where, in each structure, each R¹ is a hydrocarbyl group, M is a furan group, each R² and R³ are hydrocarbyl groups, each x is 1 to 20, each y is 0 to 20, and z is 1 to 20, each R⁴ is a hydrocarbyl, each n is 1 to 20, each R⁵ is a hydrocarbyl, each a is 1 to 20, each b is 0 to 20, and c is 1 to 20.

In other embodiments, the disclosed technology provides the described polymer composition where the hydroxyl terminated intermediate containing at least one furan functional group includes at least one compound represented by the following structures:

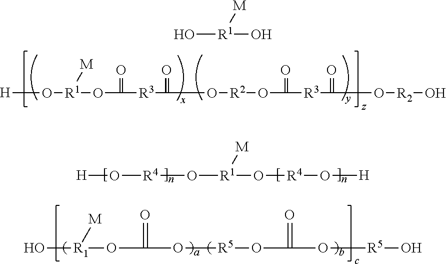

where, in each structure, each R¹ is a hydrocarbyl group, M is a furan group, each R² and R³ are hydrocarbyl groups, each x is 1 to 20, each y is 0 to 20, and z is 1 to 20, each R⁴ is a hydrocarbyl, each n is 1 to 20, each R⁵ is a hydrocarbyl, each a is 1 to 20, each b is 0 to 20, and c is 1 to 20.

It is noted that in some embodiments M may be either a furan group or a maleimide group. In particular, it is noted that in one embodiment a first TPU may be prepared using one or more of the compounds above where M is a furan group, and a second TPU may be prepared using one or more of the compounds above where M is a maleimide group, and then the first TPU and second TPU may be combined (e.g. resins of the first TPU and resin of the second TPU may be extruded together) to result in a TPU composition that is has thermally reversible crosslinking properties.

The disclosed technology provides the described polymer composition where the hydroxyl terminated intermediate containing at least one furan functional group includes a compound represented by the following structure:

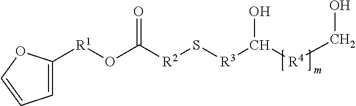

where R¹, R², R³, and R⁴ are each independently hydrocarbyl groups, and m is 0 or 1.

The disclosed technology provides the described polymer composition where the hydroxyl terminated intermediate containing at least one furan functional group includes a compound prepared by reacting a first hydroxyl terminated intermediate containing at least one furan functional group with a polymaleimide compound, resulting in a polyester polyol compound that contains at least one, but which may contain many, furan functional groups.

The disclosed technology provides the described polymer composition where the hydroxyl terminated intermediate containing at least one furan functional group includes a compound obtained from the reaction of: (i) a compound represented by the following structure:

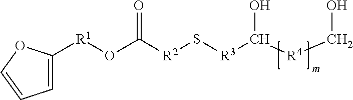

where R¹, R², R³, and R⁴ are each independently hydrocarbyl groups, and m is 0 or 1; and (ii) a polymaleimide; resulting in a polyester polyol compound containing at least one furan functional group.

The disclosed technology provides the described polymer composition where the polymaleimide comprises a compound represented by the following structure:

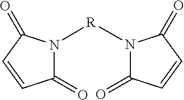

where R is a hydrocarbyl group.

The disclosed technology provides the described polymer composition where the polymaleimide comprises a compound represented by the following structure:

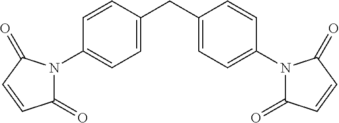 [SMILES: O=C1C=CC(=O)N1c1ccc(Cc2ccc(N3C(=O)C=CC3=O)cc2)cc1]

The disclosed technology provides the described polymer composition where the polyisocyanate component comprises an aromatic diisocyanate, an aliphatic diisocyanate, or a mixture thereof.

The disclosed technology provides the described polymer composition where the reaction mixture further includes (iii) at least one non-furan group containing chain extender, such that the furan functional group containing component serves as the polyol component of the polymer while the non-furan group containing component is a conventional chain extender. In such embodiments, the non-furan group containing chain extender includes one or more short chain glycols having from about 2 to about 10 carbon atoms.

The disclosed technology provides the described polymer composition where the reaction mixture further includes (iii) at least one non-furan group containing polyol compound, such that the furan functional group containing component serves as the chain extender of the polymer while the non-furan group containing component is a conventional polyol component. In such embodiments, the non-furan group containing polyol compound includes a polyether polyol, a polyester polyol (including but not limited to a polycaprolactone polyol), a polycarbonate polyol, a polyamide polyol, or any combination thereof.

The disclosed technology further provides a process of making any of the polymer compositions described herein, where such polymer compositions are capable of thermally reversible crosslinking The process includes the steps of: (I) reacting: (i) a hydroxyl terminated intermediate containing at least one furan functional group; (ii) a polyisocyanate component; and (iii) an optional non-furan group containing polyol; wherein the polymer composition further comprises a polymaleimide compound, where the polymaleimide compound is (a) added as a component of the polymer composition, (b) is incorporated into the structure of the hydroxyl terminated intermediate containing at least one furan functional group, or (c) both (a) and (b); where the polymer composition is capable of thermally reversible crosslinking

The disclosed technology further provides a method of reversibly increasing and/or decreasing the amount of crosslinking in a polymer composition thermally, wherein said polymer compositions includes one or more of the polymers described herein. The method includes the steps of: (I) decreasing the temperature of the polymer composition, resulting in an increase in the amount of crosslinking in the polymer composition; (II) increasing the temperature of the polymer composition, resulting in an decrease in the amount of crosslinking in the polymer composition; or (III) any combination of step (I) and step (II).

The disclosed technology further provides a method of using a hydroxyl terminated intermediate containing at least one furan functional group to prepare a polymer composition capable of thermally reversible crosslinking The method of use comprises the steps of: (I) reacting said hydroxyl terminated intermediate containing at least one furan functional group with: (i) a polyisocyanate component; and (ii) an optional non-furan group containing hydroxyl terminated intermediate. The polymer composition further comprises a polymaleimide compound, where the polymaleimide compound is (a) added as a component of the polymer composition, (b) is incorporated into the structure of the hydroxyl terminated intermediate containing at least one furan functional group, or (c) both (a) and (b).

### DETAILED DESCRIPTION

Various preferred features and embodiments will be described below by way of non-limiting illustration.

The disclosed technology provides a polymer composition that includes the reaction product obtained from a reaction mixture that includes: (i) a hydroxyl terminated intermediate containing at least one furan functional group; and (ii) a polyisocyanate component. The described polymer composition may further include a polymaleimide compound. The polymaleimide compound may be (a) added as a component of the polymer composition, (b) incorporated into the structure of the hydroxyl terminated intermediate containing at least one furan functional group, or (c) both (a) and (b). The resulting polymer composition is capable of thermally reversible crosslinking

### The Furan Containing Intermediate

The described polymers are prepared using a hydroxyl terminated intermediate containing at least one furan functional group.

In some embodiments, the hydroxyl terminated intermediate containing at least one furan functional group is used as a polyol component. In such embodiments, the hydroxyl terminated intermediate may include a polyether polyol containing at least one furan functional group, a polyester polyol containing at least one furan functional group, a polycarbonate polyol containing at least one furan functional group, a polyamide polyol containing at least one furan functional group, or any combination thereof. In such embodiments, a non-furan group containing chain extender may be used to prepare the polymer. In other embodiments, a furan group containing chain extender is used with the polyol component that contains at least one furan functional group.

In some embodiments, the hydroxyl terminated intermediate containing at least one furan functional group is used as a chain extender. In such embodiments, the hydroxyl terminated intermediate may include a short chain glycol chain extender having from about 2 to about 10 carbon atoms, a short chain amine chain extender having from about 2 to about 10 carbon atoms, or any combination thereof. In such embodiments, a non-furan group containing chain extender may be used to prepare the polymer. In other embodiments, a furan group containing chain extender is used with the polyol component that contains at least one furan functional group.

In any of the embodiments, described above, the hydroxyl terminated intermediate containing at least one furan functional group includes a compound represented by the following structure:

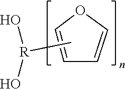

where R is a hydrocarbyl group and n is an integer from 1 to 20.

In any of the embodiments described above, the hydroxyl terminated intermediate containing at least one furan functional group includes at least one compound represented by the following structures:

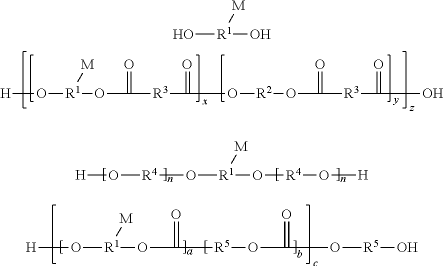

where, in each structure, each R¹ is a hydrocarbyl group, M is a furan group, each R² and R³ are hydrocarbyl groups, each x is 1 to 20, each y is 0 to 20, and z is 1 to 20, each R⁴ is a hydrocarbyl, each n is 1 to 20, each R⁵ is a hydrocarbyl, each a is 1 to 20, each b is 0 to 20, and c is 1 to 20.

In other embodiments, the disclosed technology provides the described polymer composition where the hydroxyl terminated intermediate containing at least one furan functional group includes at least one compound represented by the following structures:

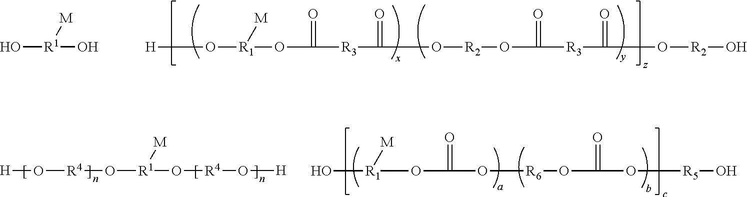

where, in each structure, each R¹ is a hydrocarbyl group, M is a furan group, each R² and R³ are hydrocarbyl groups, each x is 1 to 20, each y is 0 to 20, and z is 1 to 20, each R⁴ is a hydrocarbyl, each n is 1 to 20, each R⁵ is a hydrocarbyl, each a is 1 to 20, each b is 0 to 20, and c is 1 to 20.

The first structure provided above, containing the R¹ group and no other R groups can be used as a chain extender in the preparation of TPU materials. The second structure provided above, containing the R² and R³ groups can be used as a polyester polyol in the preparation of TPU materials. The third structure provided above, containing the R⁴ groups can be used as a polyether polyol in the preparation of TPU materials. The fourth structure provided above, containing the R⁵ groups can be used as a polycarbonate polyol in the preparation of TPU materials. Each of these materials can be used with more conventional components to prepare TPU or they can be used in combination with one or more of the other materials described above.

It is noted that in some embodiments, M may be either a furan group or a maleimide group. In particular, it is noted that in one embodiment a first TPU may be prepared using one or more of the compounds above where M is a furan group, and a second TPU may be prepared using one or more of the compounds above where M is a maleimide group, and then the first TPU and second TPU may be combined (e.g. resins of the first TPU and resin of the second TPU may be extruded together) to result in a TPU composition that has thermally reversible crosslinking properties.

In any of the embodiments described above, the hydroxyl terminated intermediate containing at least one furan functional group includes a compound represented by the following structure:

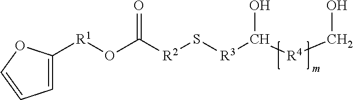

where R¹, R², R³, and R⁴ are each independently hydrocarbon groups, and m is 0 or 1. Each of the hydrocarbon groups R¹, R², R³, and R⁴ may independently contain from 1 to 10 carbon atoms, or from 1 to 5, or even from 1 to 3 carbon atoms. In some embodiments, R¹ contains 1 carbon atom (that is, a —CH₂— group), R², contains 3 carbon atoms (for example, a —CH(CH₃)CH₂— group), R³ contains 1 carbon atom (that is, a —CH₂— group), and m is zero such that no R⁴ group is present. This type of material can be produced from thioglycerol and furfuryl methacrylate.

In some embodiments, the hydroxyl terminated intermediate containing at least one furan functional group comprises a compound prepared by reacting a first hydroxyl terminated intermediate containing at least one furan functional group with a polymaleimide compound, resulting in a polyester polyol compound containing at least one furan functional group.

Any of the hydroxyl terminated intermediates that contain at least one furan functional group, which are described above, may be used to prepare these furan containing polyester polyol compounds. In such embodiments, the resulting material is used as the polyol component in the preparation of the polymer materials described above. As noted above, these furan containing polyester polyol compounds may be used in combination with one or more conventional polyol components, or in place thereof, with one of the other hydroxyl terminated intermediates that contain at least one furan functional group described above, or any combination thereof. Further, they may be used with conventional chain extenders, with the furan containing chain extenders described above, or a combination thereof.

In some embodiments, the polymer composition described above is prepared using a hydroxyl terminated intermediate containing at least one furan functional group, where the intermediate is obtained from the reaction of: (i) a compound represented by the following structure:

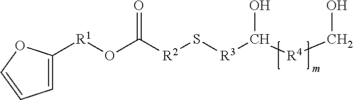

where R¹, R², R³, and R⁴ are each independently hydrocarbyl groups, and m is 0 or 1; and (ii) a polymaleimide; resulting in a polyester polyol compound containing at least one furan functional group.

The polymer compositions may further include the described polymaleimide compound, where the polymaleimide compound may be (a) added as a component of the polymer composition, (b) is incorporated into the structure of the hydroxyl terminated intermediate containing at least one furan functional group, or (c) both (a) and (b). The addition of the polymaleimide compound results in the polymer composition formed being capable of thermally reversible crosslinking

While not wishing to be bound by theory, it is believed that the polymaleimide compound acts to form a network connecting the polymer molecules together by associating with the furan groups via Diels-Alder reaction mechanism present in the polymer molecules. These interactions, and so the network across the polymer molecules, increases as the composition cools, and decreases as the compositions warms, thus providing a polymer system with thermally reversible crosslinking

The polymaleimide compounds useful in the invention include compounds represented by the following structure:

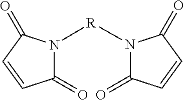

where R is a hydrocarbyl group. This R group may include aromatic groups, and in some embodiments may contain from 1 to 20 carbon atoms, or even from 6 to 20 or even 6 to 13 carbon atoms. Some examples include bis(maleimido)ethane, bis(maleimido)butane, bis(maleimido)hexane, 1,2-phenylene-bis-maleimide, and even poly(ethylene glycol) bismaleimide. See international publication WO2004035657A1 for additional detail on some of these materials.

In some embodiments, the polymaleimide includes a compound represented by the following structure:

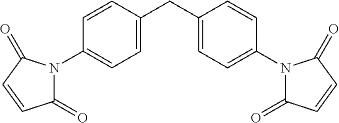 [SMILES: O=C1C=CC(=O)N1c1ccc(Cc2ccc(N3C(=O)C=CC3=O)cc2)cc1]

In some embodiments, the polymaleimide includes bismaleimide.

### The Polyisocyanate

The compositions described herein are made using a polyisocyanate component, which may include one or more polyisocyanates. In some embodiments, the polyisocyanate component includes one or more diisocyanates.

Suitable polyisocyanates include aromatic diisocyanates, aliphatic diisocyanates, or combinations thereof. In some embodiments, the polyisocyanate component includes one or more aromatic diisocyanates. In some embodiments, the polyisocyanate component is essentially free of, or even completely free of, aliphatic diisocyanates.

Examples of useful polyisocyanates include aromatic diisocyanates such as 4,4′-methylenebis(phenyl isocyanate) (MDI), m-xylene diisocyanate (XDI), phenylene-1,4-diisocyanate, naphthalene-1,5-diisocyanate, and toluene diisocyanate (TDI); as well as aliphatic diisocyanates such as isophorone diisocyanate (IPDI), 1,4-cyclohexyl diisocyanate (CHDI), decane-1,10-diisocyanate, lysine diisocyanate (LDI), 1,4-butane diisocyanate (BDI), isophorone diisocyanate (PDI), 3,3′-Dimethyl-4,4′-biphenylene diisocyanate (TODI), 1,5-naphthalene diisocyanate (NDI), and dicyclohexylmethane-4,4′-diisocyanate (H12MDI). Mixtures of two or more polyisocyanates may be used. In some embodiments, the polyisocyanate is MDI and/or H12MDI. In some embodiments, the polyisocyanate includes MDI. In some embodiments, the polyisocyanate may include H12MDI. In some embodiments, the polyisocyanate component is essentially free of, or even completely free of, hexamethylene diisocyanate (HDI).

In some embodiments, the thermoplastic polyurethane is prepared with a polyisocyanate component that includes MDI. In some embodiments, the thermoplastic polyurethane is prepared with a polyisocyanate component that consists essentially of MDI. In some embodiments, the thermoplastic polyurethane is prepared with a polyisocyanate component that consists of MDI.

In some embodiments, the thermoplastic polyurethane is prepared with a polyisocyanate component that includes (or consists essentially of, or even consists of) MDI and at least one of H12MDI, HDI, TDI, IPDI, LDI, BDI, PDI, CHDI, TODI, and NDI. In some embodiments, the polyisocyanate includes MDI, H12MDI, HDI, or any combination thereof.

### The Non Furan Polyol Component

In some embodiments, the polymers compositions described herein are made using one or more non-furan group containing polyol compounds. In some embodiments, the furan-containing intermediates described above may be used as polyol components in combination with the non-furan group containing polyol components described herein. In some embodiments, the furan-containing intermediates described above may be used as chain extender components with the non-furan group containing polyol components described herein. In still further embodiments, the furan-containing intermediates described above may be used as chain extender components and polyol components, where the non-furan group containing polyol components described herein are used as well.

Non-furan containing polyols include polyether polyols, polyester polyols, polycarbonate polyols, polysiloxane polyols, and combinations thereof so long as the polyols do not contain a furan functional group.

Suitable polyols, which may also be described as hydroxyl terminated intermediates, when present, may include one or more hydroxyl terminated polyesters, one or more hydroxyl terminated polyethers, one or more hydroxyl terminated polycarbonates, one or more hydroxyl terminated polysiloxanes, or mixtures thereof. Suitable polyols may also include amine terminated polyols.

Suitable hydroxyl terminated polyester intermediates include linear polyesters having a number average molecular weight (Mn) of from about 500 to about 10,000, from about 700 to about 5,000, or from about 700 to about 4,000, and generally have an acid number less than 1.3 or less than 0.5. The molecular weight is determined by assay of the terminal functional groups and is related to the number average molecular weight. The polyester intermediates may be produced by (1) an esterification reaction of one or more glycols with one or more dicarboxylic acids or anhydrides or (2) by transesterification reaction, i.e., the reaction of one or more glycols with esters of dicarboxylic acids. Mole ratios generally in excess of more than one mole of glycol to acid are preferred so as to obtain linear chains having a preponderance of terminal hydroxyl groups. Suitable polyester intermediates also include various lactones such as polycaprolactone typically made from ε-caprolactone and a bifunctional initiator such as diethylene glycol. The dicarboxylic acids of the desired polyester can be aliphatic, cycloaliphatic, aromatic, or combinations thereof. Suitable dicarboxylic acids which may be used alone or in mixtures generally have a total of from 4 to 15 carbon atoms and include: succinic, glutaric, adipic, pimelic, suberic, azelaic, sebacic, dodecanedioic, isophthalic, terephthalic, cyclohexane dicarboxylic, and the like. Anhydrides of the above dicarboxylic acids such as phthalic anhydride, tetrahydrophthalic anhydride, or the like, can also be used. Adipic acid is a preferred acid. The glycols which are reacted to form a desirable polyester intermediate can be aliphatic, aromatic, or combinations thereof, including any of the glycols described above in the chain extender section, and have a total of from 2 to 20 or from 2 to 12 carbon atoms. Suitable examples include ethylene glycol, 1,2-propanediol, 1,3-propanediol, 1,3-butanediol, 1,4-butanediol, 1,5-pentanediol, 1,6-hexanediol, 2,2-dimethyl-1,3-propanediol, 1,4-cyclohexanedimethanol, decamethylene glycol, dodecamethylene glycol, and mixtures thereof.

The polyol component may also include one or more polycaprolactone polyester polyols. The polycaprolactone polyester polyols useful in the technology described herein include polyester diols derived from caprolactone monomers. The polycaprolactone polyester polyols are terminated by primary hydroxyl groups. Suitable polycaprolactone polyester polyols may be made from ε-caprolactone and a bifunctional initiator such as diethylene glycol, 1,4-butanediol, or any of the other glycols and/or diols listed herein. In some embodiments, the polycaprolactone polyester polyols are linear polyester diols derived from caprolactone monomers.

Useful examples include CAPA™ 2202A, a 2000 number average molecular weight (Mn) linear polyester diol, and CAPA™ 2302A, a 3000 Mn linear polyester diol, both of which are commercially available from Perstorp Polyols Inc. These materials may also be described as polymers of 2-oxepanone and 1,4-butanediol.

The polycaprolactone polyester polyols may be prepared from 2-oxepanone and a diol, where the diol may be 1,4-butanediol, diethylene glycol, monoethylene glycol, 1,6-hexanediol, 2,2-dimethyl-1,3-propanediol, or any combination thereof. In some embodiments, the diol used to prepare the polycaprolactone polyester polyol is linear. In some embodiments, the polycaprolactone polyester polyol is prepared from 1,4-butanediol. In some embodiments, the polycaprolactone polyester polyol has a number average molecular weight from 500 to 10,000, or from 500 to 5,000, or from 1,000 or even 2,000 to 4,000 or even 3000.

Suitable hydroxyl terminated polyether intermediates include polyether polyols derived from a diol or polyol having a total of from 2 to 15 carbon atoms, in some embodiments an alkyl diol or glycol which is reacted with an ether comprising an alkylene oxide having from 2 to 6 carbon atoms, typically ethylene oxide or propylene oxide or mixtures thereof. For example, hydroxyl functional polyether can be produced by first reacting propylene glycol with propylene oxide followed by subsequent reaction with ethylene oxide. Primary hydroxyl groups resulting from ethylene oxide are more reactive than secondary hydroxyl groups and thus are preferred. Useful commercial polyether polyols include poly(ethylene glycol) comprising ethylene oxide reacted with ethylene glycol, polypropylene glycol) comprising propylene oxide reacted with propylene glycol, poly(tetramethylene ether glycol) comprising water reacted with tetrahydrofuran which can also be described as polymerized tetrahydrofuran, and which is commonly referred to as PTMEG. In some embodiments, the polyether intermediate includes PTMEG. Suitable polyether polyols also include polyamide adducts of an alkylene oxide and can include, for example, ethylenediamine adduct comprising the reaction product of ethylenediamine and propylene oxide, diethylenetriamine adduct comprising the reaction product of diethylenetriamine with propylene oxide, and similar polyamide type polyether polyols. Copolyethers can also be utilized in the described compositions. Typical copolyethers include the reaction product of THF and ethylene oxide or THF and propylene oxide. These are available from BASF as PolyTHF® B, a block copolymer, and poly THF® R, a random copolymer. The various polyether intermediates generally have a number average molecular weight (Mn) as determined by assay of the terminal functional groups which is an average molecular weight greater than about 700, such as from about 700 to about 10,000, from about 1,000 to about 5,000, or from about 1,000 to about 2,500. In some embodiments, the polyether intermediate includes a blend of two or more different molecular weight polyethers, such as a blend of 2,000 Mₙ and 1000 Mₙ PTMEG.

Suitable hydroxyl terminated polycarbonates include those prepared by reacting a glycol with a carbonate. U.S. Pat. No. 4,131,731 is hereby incorporated by reference for its disclosure of hydroxyl terminated polycarbonates and their preparation. Such polycarbonates are linear and have terminal hydroxyl groups with essential exclusion of other terminal groups. The essential reactants are glycols and carbonates. Suitable glycols are selected from cycloaliphatic and aliphatic diols containing 4 to 40, and or even 4 to 12 carbon atoms, and from polyoxyalkylene glycols containing 2 to 20 alkoxy groups per molecule with each alkoxy group containing 2 to 4 carbon atoms. Suitable diols include aliphatic diols containing 4 to 12 carbon atoms such as 1,4-butanediol, 1,5-pentanediol, neopentyl glycol, 1,6-hexanediol, 2,2,4-trimethyl-1,6-hexanediol, 1,10-decanediol, hydrogenated dilinoleylglycol, hydrogenated dioleylglycol, 3-methyl-1,5-pentanediol; and cycloaliphatic diols such as 1,3-cyclohexanediol, 1,4-dimethylolcyclohexane, 1,4-cyclohexanediol-, 1,3-dimethylolcyclohexane-, 1,4-endomethylene-2-hydroxy-5-hydroxymethyl cyclohexane, and polyalkylene glycols. The diols used in the reaction may be a single diol or a mixture of diols depending on the properties desired in the finished product. Polycarbonate intermediates which are hydroxyl terminated are generally those known to the art and in the literature. Suitable carbonates are selected from alkylene carbonates composed of a 5 to 7 member ring. Suitable carbonates for use herein include ethylene carbonate, trimethylene carbonate, tetramethylene carbonate, 1,2-propylene carbonate, 1,2-butylene carbonate, 2,3-butylene carbonate, 1,2-ethylene carbonate, 1,3-pentylene carbonate, 1,4-pentylene carbonate, 2,3-pentylene carbonate, and 2,4-pentylene carbonate. Also, suitable herein are dialkylcarbonates, cycloaliphatic carbonates, and diarylcarbonates. The dialkylcarbonates can contain 2 to 5 carbon atoms in each alkyl group and specific examples thereof are diethylcarbonate and dipropylcarbonate. Cycloaliphatic carbonates, especially dicycloaliphatic carbonates, can contain 4 to 7 carbon atoms in each cyclic structure, and there can be one or two of such structures. When one group is cycloaliphatic, the other can be either alkyl or aryl. On the other hand, if one group is aryl, the other can be alkyl or cycloaliphatic. Examples of suitable diarylcarbonates, which can contain 6 to 20 carbon atoms in each aryl group, are diphenylcarbonate, ditolylcarbonate, and dinaphthylcarbonate.

Suitable polysiloxane polyols include alpha-omega-hydroxyl or amine or carboxylic acid or thiol or epoxy terminated polysiloxanes. Examples include poly(dimethysiloxane) terminated with a hydroxyl or amine or carboxylic acid or thiol or epoxy group. In some embodiments, the polysiloxane polyols are hydroxyl terminated polysiloxanes. In some embodiments, the polysiloxane polyols have a number-average molecular weight in the range from 300 to 5,000, or from 400 to 3,000.

Polysiloxane polyols may be obtained by the dehydrogenation reaction between a polysiloxane hydride and an aliphatic polyhydric alcohol or polyoxyalkylene alcohol to introduce the alcoholic hydroxy groups onto the polysiloxane backbone.

In some embodiments, the polysiloxanes may be represented by one or more compounds having the following formula:

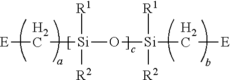

in which: each R¹ and R² are independently a 1 to 4 carbon atom alkyl group, a benzyl, or a phenyl group; each E is OH or NHR³ where R³ is hydrogen, a 1 to 6 carbon atoms alkyl group, or a 5 to 8 carbon atoms cyclo-alkyl group; a and b are each independently an integer from 2 to 8; c is an integer from 3 to 50. In amino-containing polysiloxanes, at least one of the E groups is NHR³. In the hydroxyl-containing polysiloxanes, at least one of the E groups is OH. In some embodiments, both R¹ and R² are methyl groups.

Suitable examples include alpha-omega-hydroxypropyl terminated poly(dimethysiloxane) and alpha-omega-amino propyl terminated poly(dimethysiloxane), both of which are commercially available materials. Further examples include copolymers of the poly(dimethysiloxane) materials with a poly(alkylene oxide).

The polyol component, when present, may include poly(ethylene glycol), poly(tetramethylene ether glycol), poly(trimethylene oxide), ethylene oxide capped poly(propylene glycol), poly(butylene adipate), poly(ethylene adipate), poly(hexamethylene adipate), poly(tetramethylene-co-hexamethylene adipate), poly(3-methyl-1,5-pentamethylene adipate), polycaprolactone diol, poly(hexamethylene carbonate) glycol, poly(pentamethylene carbonate) glycol, poly(trimethylene carbonate) glycol, dimer fatty acid based polyester polyols, vegetable oil based polyols, or any combination thereof.

Examples of dimer fatty acids that may be used to prepare suitable polyester polyols include Priplast™ polyester glycols/polyols commercially available from Croda and Radia® polyester glycols commercially available from Oleon.

In some embodiments, the polyol component includes a polyether polyol, a polycarbonate polyol, a polycaprolactone polyol, or any combination thereof.

In some embodiments, the polyol component includes a polyether polyol. In some embodiments, the polyol component is essentially free of or even completely free of polyester polyols. In some embodiments, the polyol component used to prepare the TPU is substantially free of, or even completely free of polysiloxanes.

In some embodiments, the polyol component includes ethylene oxide, propylene oxide, butylene oxide, styrene oxide, poly(tetramethylene ether glycol), poly(propylene glycol), poly(ethylene glycol), copolymers of poly(ethylene glycol) and poly(propylene glycol), epichlorohydrin, and the like, or combinations thereof. In some embodiments, the polyol component includes poly(tetramethylene ether glycol).

In some embodiments, the polyol has a number average molecular weight of at least 900. In other embodiments the polyol has a number average molecular weight of at least 900, 1,000, 1,500, 1,750, and/or a number average molecular weight up to 5,000, 4,000, 3,000, 2,500, or even 2,000.

In some embodiments, the polyol component comprises a polyether polyol, a polyester polyol, or a combination thereof. In some embodiments, the polyol component comprises poly(tetramethylene ether glycol), polybutylene adipate, or a combination thereof. In some embodiments, the polyol component comprises poly(tetramethylene ether glycol). In some embodiments, the polyol component comprises polybutylene adipate. In some embodiments, the polyol component comprises polytertamethylene glycol, polycaprolactone, polybutyleneadipate, or any combination thereof.

### The Chain Extender

In some embodiments, the polymers compositions described herein are made using one or more non-furan group containing chain extenders. In some embodiments, the furan-containing intermediates described above may be used as chain extenders in combination with the non-furan group containing chain extenders described herein. In some embodiments, the furan-containing intermediates described above may be used as polyol components with the non-furan group containing chain extender components described herein. In still further embodiments, the furan-containing intermediates described above may be used as polyol components and chain extenders, where the non-furan group containing chain extenders described herein are used as well.

Non-furan containing chain extenders include diols, diamines, and combination thereof.

Suitable chain extenders include relatively small polyhydroxy compounds, for example lower aliphatic or short chain glycols having from 2 to 20, or 2 to 12, or 2 to 10 carbon atoms. Suitable examples include ethylene glycol, diethylene glycol, propylene glycol, dipropylene glycol, 1,4-butanediol (BDO), 1,6-hexanediol (HDO), 1,3-butanediol, 1,5-pentanediol, neopentylglycol, 1,4-cyclohexanedimethanol (CHDM), 2,2-bis[4-(2-hydroxyethoxy) phenyl]propane (HEPP), hexamethylenediol, heptanediol, nonanediol, dodecanediol, 3-methyl-1,5-pentanediol, ethylenediamine, butanediamine, hexamethylenediamine, and hydroxyethyl resorcinol (HER), and the like, as well as mixtures thereof. In some embodiments, the chain extender includes BDO, HDO, 3-methyl-1,5-pentanediol, or a combination thereof. In some embodiments, the chain extender includes BDO. Other glycols, such as aromatic glycols could be used, but in some embodiments the TPUs described herein are essentially free of or even completely free of such materials.

In some embodiments, the chain extender used to prepare the TPU is substantially free of, or even completely free of, 1,6-hexanediol. In some embodiments, the chain extender used to prepare the TPU includes a cyclic chain extender. Suitable examples include CHDM, HEPP, HER, and combinations thereof. In some embodiments, the chain extender used to prepare the TPU includes an aromatic cyclic chain extender, for example HEPP, HER, or a combination thereof. In some embodiments, the chain extender used to prepare the TPU includes an aliphatic cyclic chain extender, for example CHDM. In some embodiments, the chain extender used to prepare the TPU is substantially free of, or even completely free of aromatic chain extenders, for example aromatic cyclic chain extenders. In some embodiments, the chain extender used to prepare the TPU is substantially free of, or even completely free of polysiloxanes.

In some embodiments, the chain extender component includes 1,4-butanediol, 2-ethyl-1,3-hexanediol, 2,2,4-trimethyl pentane-1,3-diol, 1,6-hexanediol, 1,4-cyclohexane dimethylol, 1,3-propanediol, 3-methyl-1,5-pentanediol or combinations thereof. In some embodiments, the chain extender component includes 1,4-butanediol, 3-methyl-1,5-pentanediol or combinations thereof. In some embodiments, the chain extender component includes 1,4-butanediol.

In some embodiments, the chain extender component comprises a linear alkylene diol. In some embodiments, the chain extender component comprises 1,4-butanediol, dipropylene glycol, or a combination of the two. In some embodiments, the chain extender component comprises 1,4-butanediol.

In some embodiments, the mole ratio of the chain extender to the polyol is greater than 1.5. In other embodiments, the mole ratio of the chain extender to the polyol is at least (or greater than) 1.5, 2.0, 3.5, 3.7, or even 3.8 and/or the mole ratio of the chain extender to the polyol may go up to 5.0, or even 4.0.

The thermoplastic polyurethanes described herein may also be considered to be thermoplastic polyurethane (TPU) compositions. In such embodiments, the compositions may contain one or more TPU. These TPU are prepared by reacting: a) the polyisocyanate component described above; b) the polyol component described above; and c) the chain extender component described above, where the reaction may be carried out in the presence of a catalyst. At least one of the TPU in the composition must meet the parameters described above making it suitable for solid freeform fabrication, and in particular fused deposition modeling.

In some embodiments, the chain extenders are diols of the general formula HO—(CH₂)ₓ—OH wherein x is an integer from 9 to 16. In other embodiments, x is an integer from 9 to 12. In other embodiments, x is the integer 9 or 12. Useful diol chain extenders include 1,9-nonanediol, 1,10-decanediol, 1,11-undecanediol, 1,12-dodecanediol, or a combination thereof. In some embodiments, the chain extender component includes (or consists essentially of, or even consists of) 1,9-nonanediol, 1,10-decanediol, 1,11-undecanediol, 1,12-dodecanediol, or a combination thereof. In some embodiments, the chain extender component includes (or consists essentially of, or even consists of 1,9-nonanediol, 1,12-dodecanediol, or a combination thereof.

In some embodiments, the chain extender component may further include one or more additional chain extenders. These additional chain extenders are not overly limited and may include diols (other than those described above), diamines, and combinations thereof.

In some embodiments, the chain extender component includes 1,4-butanediol, 1,6-hexanediol, or any combination thereof.

### The Polymer Compositions

The polymer compositions described herein may in some embodiments be described as thermoplastic polyurethane (TPU) compositions. They may contain one or more TPU. These TPU are prepared by reacting: a) the polyisocyanate component(s) described above; b) the polyol component(s) described above; and c) the chain extender component(s) described above.

The described compositions include the polymer compositions described above and also polymers compositions that include such polymers and one or more additional components. These additional components include other polymeric materials that may be blended with the polymer described herein. These additional components include one or more additives that may be added to the polymer composition, or blend, to impact the properties of the composition.

The polymer composition and/or TPU described herein may also be blended with one or more other polymers. The polymers with which the TPU described herein may be blended are not overly limited. In some embodiments, the described compositions include a two or more of the described TPU materials. In some embodiments, the compositions include at least one of the described TPU materials and at least one other polymer, which is not one of the described TPU materials.

Polymers that may be used in combination with the TPU materials described herein also include more conventional TPU materials such as non-caprolactone polyester-based TPU, polyether-based TPU, or TPU containing both non-caprolactone polyester and polyether groups. Other suitable materials that may be blended with the TPU materials described herein include polycarbonates, polyolefins, styrenic polymers, acrylic polymers, polyoxymethylene polymers, polyamides, polyphenylene oxides, polyphenylene sulfides, polyvinylchlorides, chlorinated polyvinylchlorides, polylactic acids, or combinations thereof.

Polymers for use in the blends described herein include homopolymers and copolymers. Suitable examples include: (i) a polyolefin (PO), such as polyethylene (PE), polypropylene (PP), polybutene, ethylene propylene rubber (EPR), polyoxyethylene (POE), cyclic olefin copolymer (COC), or combinations thereof; (ii) a styrenic, such as polystyrene (PS), acrylonitrile butadiene styrene (ABS), styrene acrylonitrile (SAN), styrene butadiene rubber (SBR or HIPS), polyalphamethylstyrene, styrene maleic anhydride (SMA), styrene-butadiene copolymer (SBC) (such as styrene-butadiene-styrene copolymer (SBS) and styrene-ethylene/butadiene-styrene copolymer (SEBS)), styrene-ethylene/propylene-styrene copolymer (SEPS), styrene butadiene latex (SBL), SAN modified with ethylene propylene diene monomer (EPDM) and/or acrylic elastomers (for example, PS-SBR copolymers), or combinations thereof; (iii) a thermoplastic polyurethane (TPU) other than those described above; (iv) a polyamide, such as Nylon™, including polyamide 6,6 (PA66), polyamide 1,1 (PA11), polyamide 1,2 (PA12), a copolyamide (COPA), or combinations thereof; (v) an acrylic polymer, such as polymethyl acrylate, polymethylmethacrylate, a methyl methacrylate styrene (MS) copolymer, or combinations thereof; (vi) a polyvinylchloride (PVC), a chlorinated polyvinylchloride (CPVC), or combinations thereof; (vii) a polyoxyemethylene, such as polyacetal; (viii) a polyester, such as polyethylene terephthalate (PET), polybutylene terephthalate (PBT), copolyesters and/or polyester elastomers (COPE) including polyether-ester block copolymers such as glycol modified polyethylene terephthalate (PETG), polylactic acid (PLA), polyglycolic acid (PGA), copolymers of PLA and PGA, or combinations thereof; (ix) a polycarbonate (PC), a polyphenylene sulfide (PPS), a polyphenylene oxide (PPO), or combinations thereof; or combinations thereof.

In some embodiments, these blends include one or more additional polymeric materials selected from groups (i), (iii), (vii), (viii), or some combination thereof. In some embodiments, these blends include one or more additional polymeric materials selected from group (i). In some embodiments, these blends include one or more additional polymeric materials selected from group (iii). In some embodiments, these blends include one or more additional polymeric materials selected from group (vii). In some embodiments, these blends include one or more additional polymeric materials selected from group (viii).

The additional additives suitable for use in the TPU compositions described herein are not overly limited. Suitable additives include pigments, UV stabilizers, UV absorbers, antioxidants, lubricity agents, heat stabilizers, hydrolysis stabilizers, cross-linking activators, flame retardants, layered silicates, fillers, colorants, reinforcing agents, adhesion mediators, impact strength modifiers, antimicrobials, and any combination thereof.

In some embodiments, the additional component is a flame retardant. Suitable flame retardants are not overly limited and may include a boron phosphate flame retardant, a magnesium oxide, a dipentaerythritol, a polytetrafluoroethylene (PTFE) polymer, or any combination thereof. In some embodiments, this flame retardant may include a boron phosphate flame retardant, a magnesium oxide, a dipentaerythritol, or any combination thereof. A suitable example of a boron phosphate flame retardant is BUDIT 326, commercially available from Budenheim USA, Inc. When present, the flame retardant component may be present in an amount from 0 to 10 weight percent of the overall TPU composition, in other embodiments from 0.5 to 10, or from 1 to 10, or from 0.5 or 1 to 5, or from 0.5 to 3, or even from 1 to 3 weight percent of the overall TPU composition.

The TPU compositions described herein may also include additional additives, which may be referred to as a stabilizer. The stabilizers may include antioxidants such as phenolics, phosphites, thioesters, and amines, light stabilizers such as hindered amine light stabilizers and benzothiazole UV absorbers, and other process stabilizers and combinations thereof. In one embodiment, the preferred stabilizer is Irganox 1010 from BASF and Naugard 445 from Chemtura. The stabilizer is used in the amount from about 0.1 weight percent to about 5 weight percent, in another embodiment from about 0.1 weight percent to about 3 weight percent, and in another embodiment from about 0.5 weight percent to about 1.5 weight percent of the TPU composition.

In addition, various conventional inorganic flame retardant components may be employed in the TPU composition. Suitable inorganic flame retardants include any of those known to one skilled in the art, such as metal oxides, metal oxide hydrates, metal carbonates, ammonium phosphate, ammonium polyphosphate, calcium carbonate, antimony oxide, clay, mineral clays including talc, kaolin, wollastonite, nanoclay, montmorillonite clay which is often referred to as nano-clay, and mixtures thereof. In one embodiment, the flame retardant package includes talc. The talc in the flame retardant package promotes properties of high limiting oxygen index (LOI). The inorganic flame retardants may be used in the amount from 0 to about 30 weight percent, from about 0.1 weight percent to about 20 weight percent, in another embodiment about 0.5 weight percent to about 15 weight percent of the total weight of the TPU composition.

Still further optional additives may be used in the TPU compositions described herein. The additives include colorants, antioxidants (including phenolics, phosphites, thioesters, and/or amines), antiozonants, stabilizers, inert fillers, lubricants, inhibitors, hydrolysis stabilizers, light stabilizers, hindered amines light stabilizers, benzotriazole UV absorber, heat stabilizers, stabilizers to prevent discoloration, dyes, pigments, inorganic and organic fillers, reinforcing agents and combinations thereof.

All of the additives described above may be used in an effective amount customary for these substances. The non-flame retardants additives may be used in amounts of from about 0 to about 30 weight percent, in one embodiment from about 0.1 to about 25 weight percent, and in another embodiment about 0.1 to about 20 weight percent of the total weight of the TPU composition.

These additional additives can be incorporated into the components of, or into the reaction mixture for, the preparation of the TPU resin, or after making the TPU resin. In another process, all the materials can be mixed with the TPU resin and then melted or they can be incorporated directly into the melt of the TPU resin.

The polymer composition capable of thermally reversible crosslinking described above may be prepared by a process that includes the steps of: (I) reacting (i) a hydroxyl terminated intermediate containing at least one furan functional group; (ii) a polyisocyanate component; and (iii) an optional non-furan group containing polyol; wherein the polymer composition further includes a polymaleimide compound, where the polymaleimide compound is (a) added as a component of the polymer composition, (b) is incorporated into the structure of the hydroxyl terminated intermediate containing at least one furan functional group, or (c) both (a) and (b); where the resulting polymer composition is capable of thermally reversible crosslinking

It is noted the invention also provides a method where the amount of crosslinking in a polymer composition may be reversibly increased or decreased. Such a method, of reversibly increasing and/or decreasing the amount of crosslinking in a polymer composition thermally, wherein said polymer compositions includes any of those described above, includes the steps of: (I) decreasing the temperature of the polymer composition, resulting in an increase in the amount of crosslinking in the polymer composition; (II) increasing the temperature of the polymer composition, resulting in an decrease in the amount of cross-linking in the polymer composition; or (III) any combination of step (I) and step (II).

It is noted the invention also provides a method of using a hydroxyl terminated intermediate containing at least one furan functional group to prepare a polymer composition capable of thermally reversible crosslinking Such a method of use includes the steps of: (I) reacting said hydroxyl terminated intermediate containing at least one furan functional group with (i) a polyisocyanate component; and (ii) an optional non-furan group containing hydroxyl terminated intermediate; wherein the polymer composition further includes a polymaleimide compound, where the polymaleimide compound is (a) added as a component of the polymer composition, (b) is incorporated into the structure of the hydroxyl terminated intermediate containing at least one furan functional group, or (c) both (a) and (b).

These processes and methods may further include the step of: mixing the composition of step with one or more blend components, including one or more additional polymeric materials, including any of those described above; mixing the composition with one or more additional additives which may include one or more pigments, UV stabilizers, UV absorbers, antioxidants, lubricity agents, heat stabilizers, hydrolysis stabilizers, cross-linking activators, flame retardants, layered silicates, fillers, colorants, reinforcing agents, adhesion mediators, impact strength modifiers, and antimicrobials.

The TPU materials and/or compositions described herein may be used in the preparation of one or more articles. The specific type of articles that may be made from the TPU materials and/or compositions described herein are not overly limited.

The amount of each chemical component described is presented exclusive of any solvent or diluent oil, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

It is known that some of the materials described above may interact in the final formulation, so that the components of the final formulation may be different from those that are initially added. For instance, metal ions (of, e.g., a flame retardant) can migrate to other acidic or anionic sites of other molecules. The products formed thereby, including the products formed upon employing the composition of the technology described herein in its intended use, may not be susceptible of easy description. Nevertheless, all such modifications and reaction products are included within the scope of the technology described herein; the technology described herein encompasses the composition prepared by admixing the components described above.

### EXAMPLES

The technology described herein may be better understood with reference to the following non-limiting examples.

### Example 1

A furfuryl containing diol is prepared by the following steps. Furfuryl methacrylate (10.78 g, 64.9 mmol) and thioglycerol (6.88 g, 63.6 mmol) are added to a round-bottomed flask equipped with a magnetic stirbar at room temperature with 100 ml of acetone. Dimethylphenylphosphine (0.18 g, 1.3 mmol) is then added and the solution is left to stir in air for 2 hours. The acetone is then removed under vacuum yielding a light yellow oil. The oil is washed with brine and hexane, with any volatiles removed under reduced pressure. A colourless oil is collected and stored at −18° C. as a white solid. The yield for this example was 90%.

### Example 2

A furfuryl 2,2-bis(hydroxymethyl)propionate is prepared by the following steps. To an oven dried 500 mL round-bottomed flask, a stir-bar, acetonide protected 2,2-bis(hydroxymethyl)propionic acid (2 g, 1.1×10⁻³ mol), N,N′-dicyclohexylcarbodiimide (DCC) (2.6 g, 1.3×10⁻³ mol), 4-dimethylaminopyridine (DMAP) (2.5×10⁻⁴ mol) are added and flushed with nitrogen for 1 hour. Anhydrous tetrahydrofuran (150 ml) is canulated into the system and furfuryl alcohol (1.24 g, 1.2×10⁻³ mol) is added dropwise over 1 hour. The reaction is left stirring for 6 days, cooled, filtered and the solvents removed under reduced pressure. The resulting yellow oil is purified on a silica gel column with mixed solvent of ethyl acetate/hexane (4:6) resulting in a colorless liquid. The acetonide deprotecting group is removed by mixing the colorless liquid with DOWEX 50W X8 acidic resin in 50 mL methanol for 1 hour. The solvents are removed under pressure and the resulting brown oil is purified on a silica gel column with mixed solvent of ethyl acetate/hexane (4:6) resulting in a colorless liquid.

### Example 3

A hydroxyl terminated intermediate containing at least one furan functional group is prepared by the following steps. This examples uses polybutylene adipate and furfuryl 2,2-bis(hydroxymethyl)propionate. To a 100 mL three necked round-bottomed flask equipped with an overhead stirrer and a Dean-Stark condenser are added adipic acid (10.5 g, 71.9 mmol), butanediol (8.35 ml, 81 mmol) and 2,2-bis(hydroxymethyl)propionate (4.35 g, 4.8 mmol). The mixture is heated, under nitrogen, to 120° C. until homogeneous. Samples are taken periodically for acid end group evaluation by acid titration and SEC analysis. The mixture is cooled and 5 drops of dibutyl tindilaurate added. The mixture is reheated under vacuum (˜3×10⁻² mbar) to 120° C. until the M_{w} by GPC increased to over 2000 Da (approximately 6 days). The cooled polyester is dissolved in dichloromethane and precipitated into hexane yielding a light yellow powder. The yield for this example was 81%.

### Example 4

A hydroxyl terminated intermediate containing at least one furan functional group is prepared by the following steps. This examples uses polybutylene adipate and furfuryl 2,2-bis(hydroxymethyl)propionate. To a 100 mL three neck round-bottomed flask equipped with an overhead stirrer, a Dean-Stark condenser are added adipic acid (0.69 g, 4.8×10⁻³ mol), 1,4-butanediol (0.44 g, 4.8×10⁻³ mol) and furfuryl 2,2-bis(hydroxymethyl)propionate. The mixture is heated, under nitrogen, to 130° C. for 72 Hrs. The mixture is cooled and 5 drops of dibutyl tin dilaurate added. The mixture is reheated under vacuum to 130° C. for 72 hours. The cooled polyester is dissolved in dichloromethane and precipitated into hexane.

### Example 5

A hydroxyl terminated intermediate containing at least one furan functional group is prepared by the following steps. This example uses polybutylene adipate and scandium triflate resin. To a 100 mL three necked round-bottomed flask equipped with an overhead stirrer and a Dean-Stark condenser are added adipic acid (12.75 g, 87.2 mmol), scandium triflate (0.21 g, 0.4 mmol) and butanediol (10.6 ml, 116.3 mmol). The mixture is heated, under nitrogen, to 80° C. until homogeneous (approximately 2 hours). Samples are taken periodically for acid end group evaluation by acid titration and SEC analysis. The mixture is reheated under vacuum (˜3×10⁻² mbar) to 80° C. until the M_{w} by GPC increased to over 2,000 Da (approximately 2 hours). The cooled polyester is dissolved in dichloromethane and precipitated into hexane yielding a white powder. The yield for this example was 90%.

### Example 6

A hydroxyl terminated intermediate containing at least one furan functional group is prepared by the following steps. This example uses polybutylene adipate and furfuryl 2,2-bis(hydroxymethyl)propionate. To a 100 mL three neck round-bottomed flask equipped with an overhead stirrer, a Dean-Stark condenser are added adipic acid (0.70 g, 4.8×10⁻³ mol), 1,4-butanediol (0.44 g, 4.9×10⁻³ mol) and furfuryl 2,2-bis(hydroxymethyl)propionate (0.04 g, 2×10⁻⁴ mol). The mixture is heated, under nitrogen, to 130° C. for 72 Hrs. The mixture is cooled and 5 drops of dibutyl tin dilaurate added. The mixture is reheated under vacuum to 130° C. for 72 hours. The cooled polyester is dissolved in dichloromethane and precipitated into hexane.

### Example Set 7

A series hydroxyl terminated intermediates containing at least one furan functional group are crosslinked and de-crosslinked by the following steps. This example is carried out with each of the hydroxyl terminated intermediates described above, Examples 1 to 5, correspond to Examples 6-1 to 6-5. For each example in this set, the hydroxyl terminated intermediate is stirred with 1,1′-(methylenedi-4,1-phenylene) bismaleimide, in a 6 times excess, for 48 hours at 70° C. The NMR spectra of before and after, for each example indicates a successful binding of the furan and maleimide groups with a complete shift and separation of the peaks a and b, which relate to the unbound furan to d and e which correlate with the bound furan. This is accompanied with a rise in Mₙ from 580 to 770 g mol⁻¹. The results from one of the examples are summarized in the table below.

### Example Set 8

A series hydroxyl terminated intermediates containing at least one furan functional group are crosslinked and de-crosslinked by the following steps. This example is carried out with each of the hydroxyl terminated intermediates described above, Examples 1 to 5, correspond to Examples 7-1 to 7-5. For each example in this set, the hydroxyl terminated intermediate (10 g, 36.5 mmol) is dissolved in 100 ml tetrahydrofuran and added to a 250 ml round-bottomed flask fitted with a condenser along with 1,1′-(methylenedi-4,1-phenylene) bismaleimide (6.54 g, 18.25 mmol). The reaction mixture is placed under nitrogen and heated to 70° C. for 24 hours. The tetrahydrofuran is removed under vacuum and the brown oil dissolved in 50° C. methanol and any insolubles are filtered off. The methanol is removed under vacuum and then the resulting yellow solid recrystallized in isopropyl alcohol to yield a light yellow crystalline solid.

### Example Set 9

A series polyurethanes is made using the hydroxyl terminated intermediates containing at least one furan functional group by the following steps. This example is carried out with each of the hydroxyl terminated intermediates described above, Examples 1 to 5, correspond to Examples 8-1 to 8-5. For each example in this set, the hydroxyl terminated intermediate is reacted with commercially available toluene diisocyanate (TDI) to form a polyurethane with a number average molecular weight (Mn) of about 3,200 Da (as measured by GPC). Each polyurethane is crosslinked with bismaleimide (1,1′-(methylenedi-4,1-phenylene)bismaleimide) to give an insoluble gel. Each gel is left stirring in DMF overnight and a GPC of the solution taken is to prove the change in properties. Each gel is heated up to 120° C. for 30 minutes in dioxane and a sample is taken and analyzed by GPC. In each example the Mn does not returned to the same as the original (often returning to an Mn of about 5000 Da) showing that the reversible nature of the crosslinking is not 100% efficient, leaving some polyurethane chains still crosslinked, but it is sufficient to show a considerable change in properties. While not wishing to be bound by theory it is believed the peak at low molecular weight relates to the released bismaleimide. When the samples are heated back to 50° C. again, the polyurethane samples once again gelled, displaying the reversibility of this reaction.

Each of the documents referred to above is incorporated herein by reference, including any prior applications, whether or not specifically listed above, from which priority is claimed. The mention of any document is not an admission that such document qualifies as prior art or constitutes the general knowledge of the skilled person in any jurisdiction. Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the technology described herein can be used together with ranges or amounts for any of the other elements.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the basic and novel characteristics of the composition or method under consideration. That is “consisting essentially of” permits the inclusion of substances that do not materially affect the basic and novel characteristics of the composition under consideration.

While certain representative embodiments and details have been shown for the purpose of illustrating the subject technology described herein, it will be apparent to those skilled in this art that various changes and modifications can be made therein without departing from the scope of the subject invention. In this regard, the scope of the technology described herein is to be limited only by the following claims.

What is claimed is:

1. A polymer composition comprising the reaction product obtained from a reaction mixture comprising:
a hydroxyl terminated intermediate containing at least one furan functional group;
(ii) a polyisocyanate component.

2. The polymer composition of claim 1 wherein the polymer composition further comprises a polymaleimide compound, where the polymaleimide compound is (a) added as a component of the polymer composition, (b) is incorporated into the structure of the hydroxyl terminated intermediate containing at least one furan functional group, or (c) both (a) and (b);
where the polymer composition is capable of thermally reversible crosslinking.

3. The polymer composition of claim 1 wherein the hydroxyl terminated intermediate containing at least one furan functional group comprises a polyether polyol containing at least one furan functional group, a polyester polyol containing at least one furan functional group, a polycarbonate polyol containing at least one furan functional group, a polyamide polyol containing at least one furan functional group, or any combination thereof;
wherein the reaction mixture further comprises (iii) at least one non-furan group containing chain extender.

4. The polymer composition of claim 1 wherein the hydroxyl terminated intermediate containing at least one furan functional group comprises a short chain glycol chain extender having from about 2 to about 10 carbon atoms, a short chain amine chain extender having from about 2 to about 10 carbon atoms, or any combination thereof,
wherein the reaction mixture further comprises (iii) at least one non-furan group containing polyol compound.

5. The polymer composition of claim 1 wherein the hydroxyl terminated intermediate containing at least one furan functional group comprises a compound represented by the following structure: 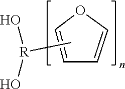
where R is a hydrocarbyl group and n is an integer from 1 to 20.

6. The polymer composition of claim 1 wherein the hydroxyl terminated intermediate containing at least one furan functional group comprises at least one compound represented by the following structures: 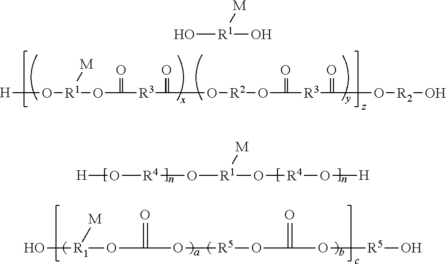
where, in each structure, each R¹ is a hydrocarbyl group, M is a furan group, each R² and R³ are hydrocarbyl groups, each x is 1 to 20, each y is 0 to 20, and z is 1 to 20, each R⁴ is a hydrocarbyl, each n is 1 to 20, each R⁵ is a hydrocarbyl, each a is 1 to 20, each b is 0 to 20, and c is 1 to 20.

7. The polymer composition of claim 1 wherein the hydroxyl terminated intermediate containing at least one furan functional group comprises a compound represented by the following structure: 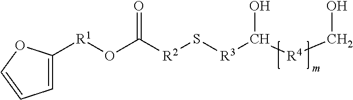
where R¹, R², R³, and R⁴ are each independently hydrocarbyl groups, and m is 0 or 1.

8. The polymer composition of claim 1 wherein the hydroxyl terminated intermediate containing at least one furan functional group comprises a compound prepared by reacting a first hydroxyl terminated intermediate containing at least one furan functional group with a polymaleimide compound, resulting in a polyester polyol compound containing at least one furan functional group.

9. The polymer composition of claim 1 wherein the hydroxyl terminated intermediate containing at least one furan functional group comprises a compound obtained from the reaction of:
a compound represented by the following structure: 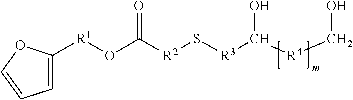
where R¹, R², R³, and R⁴ are each independently hydrocarbon groups, and m is 0 or 1; and
(ii) a polymaleimide;
resulting in a polyester polyol compound containing at least one furan functional group.

10. The polymer composition of claim 1 wherein the polymaleimide comprises a compound represented by the following structure: 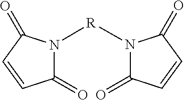
where R is a hydrocarbyl group.

11. The polymer composition of claim 1 wherein the polymaleimide comprises a compound represented by the following structure:

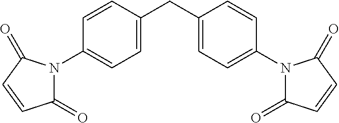 [SMILES: O=C1C=CC(=O)N1c1ccc(Cc2ccc(N3C(=O)C=CC3=O)cc2)cc1]

12. The polymer of claim 1 wherein the polyisocyanate component comprises an aromatic diisocyanate, an aliphatic diisocyanate, or a mixture thereof.

13. The polymer of claim 3 wherein the non-furan group containing chain extender comprises one or more short chain glycols having from about 2 to about 10 carbon atoms.

14. The polymer of claim 4 wherein the at least one non-furan group containing polyol compound comprises a polyether polyol, a polyester polyol, a polycarbonate polyol, a polyamide polyol, or any combination thereof.

15. A process of making a polymer composition capable of thermally reversible crosslinking, said process comprising the steps of:
(I) reacting
(i) a hydroxyl terminated intermediate containing at least one furan functional group;
(ii) a polyisocyanate component; and
(iii) an optional non-furan group containing polyol
wherein the polymer composition further comprises a polymaleimide compound, where the polymaleimide compound is (a) added as a component of the polymer composition, (b) is incorporated into the structure of the hydroxyl terminated intermediate containing at least one furan functional group, or (c) both (a) and (b);
where the polymer composition is capable of thermally reversible crosslinking.

16. A method of reversibly increasing and/or decreasing the amount of crosslinking in a polymer composition thermally, wherein said polymer compositions comprises the polymer of claim 1; said method comprising the step of:
(I) decreasing the temperature of the polymer composition, resulting in an increase in the amount of crosslinking in the polymer composition;
(II) increasing the temperature of the polymer composition, resulting in an decrease in the amount of crosslinking in the polymer composition; or
(III) any combination of step (I) and step (II).

17. A method of using a hydroxyl terminated intermediate containing at least one furan functional group to prepare a polymer composition capable of thermally reversible crosslinking, said method of use comprising the steps of:
(I) reacting said hydroxyl terminated intermediate containing at least one furan functional group with
(i) a polyisocyanate component; and
(ii) an optional non-furan group containing hydroxyl terminated intermediate.
wherein the polymer composition further comprises a polymaleimide compound, where the polymaleimide compound is (a) added as a component of the polymer composition, (b) is incorporated into the structure of the hydroxyl terminated intermediate containing at least one furan functional group, or (c) both (a) and (b).
